(19) United States
(12) Patent Application Publication
(10) Pub. No.: US 2007/0124786 A1
(43) Pub. Date: May 31, 2007

(54) Home network-broadcasting linking system and method for mutually using multimedia contents between home network and broadcasting

(76) Inventors: Dong-Hee Kim, Daegu (KR); Dong-Hwan Park, Daejon (KR); Hyun Park, Gyeonggi-do (KR); Kyeong-Deok Moon, Daejon (KR)

Correspondence Address: LADAS & PARRY LLP, 224 SOUTH MICHIGAN AVENUE, SUITE 1600, CHICAGO, IL, 60604, US

(21) Appl. No.: 11/605,180

(22) Filed: Nov. 28, 2006

(30) Foreign Application Priority Data
Nov. 28, 2005 (KR) 10-2005-0114392

(51) Int. Cl. H04N 7/173

(52) U.S. Cl. 725/105

(57) ABSTRACT

Provided is a home network-broadcasting linking system and method for using multimedia contents of both a home network and broadcasting network. The system includes: a home network means which collects/manages a home network multimedia contents list and a broadcasting contents list, provides the contents list and repeats the requested contents; a broadcasting means which receives a broadcasting signal and divides the broadcasting signal; a home network-broadcasting linking means which transforms the home network multimedia contents list into a broadcasting contents list format, transforms the broadcasting contents list into a home network multimedia contents list format and transmits the broadcasting contents list; and an image process and user interface (UI) means which provides the home network multimedia contents list and the broadcasting contents list, transmits user selection information, receives the home network multimedia contents or the broadcasting contents and performs an image signal process.

### FIELD OF THE INVENTION

The present invention relates to a home network-broadcasting linking system and method for using multimedia contents of both home network and broadcasting network; and, more particularly, to a network-broadcasting linking system and method, which can recognize multimedia contents list both in a home network and a broadcasting network by exchanging a contents list collected in a home network middleware and a contents list collected in a broadcasting module with each other through format transformation, thereby restoring broadcasting program contents in a home network terminal, i.e., a terminal accessing to the home network, and multimedia contents of the home network in a television (TV).

### DESCRIPTION OF RELATED ART

As a home network technology advances, a technology for storing multimedia contents in a home server or a media server, searching and restoring the multimedia contents has been developed. A user can search contents in the home network by accessing to the home network and restore desired contents with a desired terminal.

Meanwhile, broadcasting programs can be checked on a television (TV) screen through Electronic Program Guide (EPG), which provides a program schedule onto a TV screen.

Currently, home network multimedia contents can be shown only in a home network terminal and a broadcasting programs are shown only on TV. Although there is a terminal product for providing a Video on Demand (VoD) service through TV, the product does not simultaneously provide the home network multimedia contents and the EPG information.

That is, since the terminal product provides a home network mode and a broadcasting mode separately, there is a problem that it can only search and restore home network multimedia contents in the home network mode, and receive the EPG information and watch a TV program in the broadcasting mode.

Also, it is required to additionally mount a TV tuner module in a terminal to watch the TV program in the home network terminal. Since tuner modules in the home network terminal provide different interfaces such as Universal Serial Bus (USB) and peripheral component interconnect (PCI), there is another problem that the tuner module can be mounted only on a terminal having the interface of the tuner module.

### SUMMARY OF THE INVENTION

It is, therefore, an object of the present invention to provide a network-broadcasting linking system and method, which can recognize multimedia contents list of both home network and broadcasting network by exchanging a contents list collected in home network middleware and a contents list collected in a broadcasting module with each other through a format transformation, thereby restoring broadcasting program contents in a home network terminal, i.e., a terminal accessing to the home network, and multimedia contents of a home network in a television (TV).

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided a home network-broadcasting linking system for mutually using multimedia contents of a home network and program contents of broadcasting in the broadcasting and the home network, including: a home network module which collects/manages a home network multimedia contents list and a broadcasting contents list transformed into a home network format, provides the contents list upon request of a home network terminal and repeats the home network multimedia contents or the broadcasting contents for restoration in the home network terminal or on TV; a broadcasting module which receives a broadcasting signal transmitted through a broadcasting network and separates the broadcasting signal into the broadcasting contents list and the broadcasting contents; a home network-broadcasting linking system which transforms the home network multimedia contents list collected in the home network module into a broadcasting contents list format, transforms the broadcasting contents list separated from the broadcasting module into a home network multimedia contents list format and transmits the home network multimedia contents list to the home network module; and an image process and user interface (UI) module which provides the home network multimedia contents list and the broadcasting contents list transformed into the broadcasting format, transmits user selection information to the home network module or the broadcasting module based on a type of the contents selected by the user, receives the home network multimedia contents or the broadcasting contents and performs an image signal process on the home network multimedia contents or the broadcasting contents for restoration on TV.

In accordance with another aspect of the present invention, there is provided a home network-broadcasting linking method for restoring broadcasting program contents or home network multimedia contents on TV, including the steps of: a) collects a home network multimedia contents list from home network terminals, transforms/manages the home network multimedia contents list into a broadcasting contents list format, collects a broadcasting contents list from the broadcasting signal, transforms the broadcasting contents list into the home network multimedia contents list format and collects/manages the home network multimedia contents list; b) operating Electronic Program Guide (EPG) upon request of the user and providing the broadcasting contents list and the home network multimedia contents list which are managed in the step a) through TV; c) determining whether contents requested by a user are the home network multimedia contents or the broadcasting contents based on channel-address mapping information when the channel information is inputted from the user; d) when the contents requested by the user are the broadcasting contents, receiving the broadcasting signal of the channel selected by the user based on the channel information, and separating the broadcasting contents from the transmitted broadcasting signal and transmits the broadcasting contents to TV; and e) when the contents requested by the user are the home network multimedia contents, changing the channel information into address information based on the channel-address mapping information and transmits the transmitted home network multimedia contents to TV when the home network multimedia contents are requested to the home network terminal corresponding to the address information.

In accordance with another aspect of the present invention, there is provided a home network-broadcasting linking method for restoring broadcasting program contents or home network multimedia contents in a home network terminal, including the steps of: a) collecting a home network multimedia contents list from home network terminals, transforms/manages the home network multimedia contents list into a broadcasting contents list format, collects a broadcasting contents list from the broadcasting signal, transforms/manages the broadcasting contents list into the home network multimedia contents list format; b) providing the broadcasting contents list and the home network multimedia contents list which are managed in the step a) upon request of the user home network terminal; c) receiving contents request information from the user home network terminal and determining a type of the contents based on address information of the requested contents; d) when the requested contents are the broadcasting contents, receiving the broadcasting signal of the channel selected by the user based on channel information corresponding to address information of the contents request information, separating the broadcasting contents from the transmitted broadcasting signal and transmitting the broadcasting contents to the user home network terminal; and e) when the requested contents are the home network multimedia contents, requesting the home network multimedia contents to the home network terminal corresponding to the address information of the contents request information, and transmitting the home network multimedia contents transmitted as a response to the user home network terminal.

The present invention transforms a format of the home network multimedia contents list, displays the transformed contents list on TV with EPG information of TV. TV restores and shows the home network multimedia contents to the user as an actual broadcasting program and transforms a format of EPG information such that the home network terminals can recognize the EPG information. Accordingly, the home network terminal can recognize and use the broadcasting program contents list as it recognizes and uses the home network multimedia contents list.

That is, in the present invention, the user can check the home network multimedia contents as well as the broadcasting program contents through EPG, select and watch desired contents on TV by using a remote controller. Also, the user can check the broadcasting program contents list by using the home network terminal and restore the broadcasting program contents in the home network terminal of the user or other home network terminal.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a home network-broadcasting linking system for sharing multimedia contents between a home network and a broadcasting network in accordance with an embodiment of the present invention;

FIG. 2 is a policy table for determining whether to restore contents in a resource manager of FIG. 1;

FIG. 3 is a flowchart describing a home network-broadcasting linking method for restoring home network contents and/or broadcasting contents on TV in accordance with an embodiment of the present invention;

FIG. 4 is a flowchart describing a home network-broadcasting linking method for restoring the broadcasting contents and/or home network multimedia contents in a home network terminal in accordance with an embodiment of the present invention; and

FIG. 5 shows how mapping information between channels and the URL is formed in a EPG-application manager in accordance with an embodiment of the present invention.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

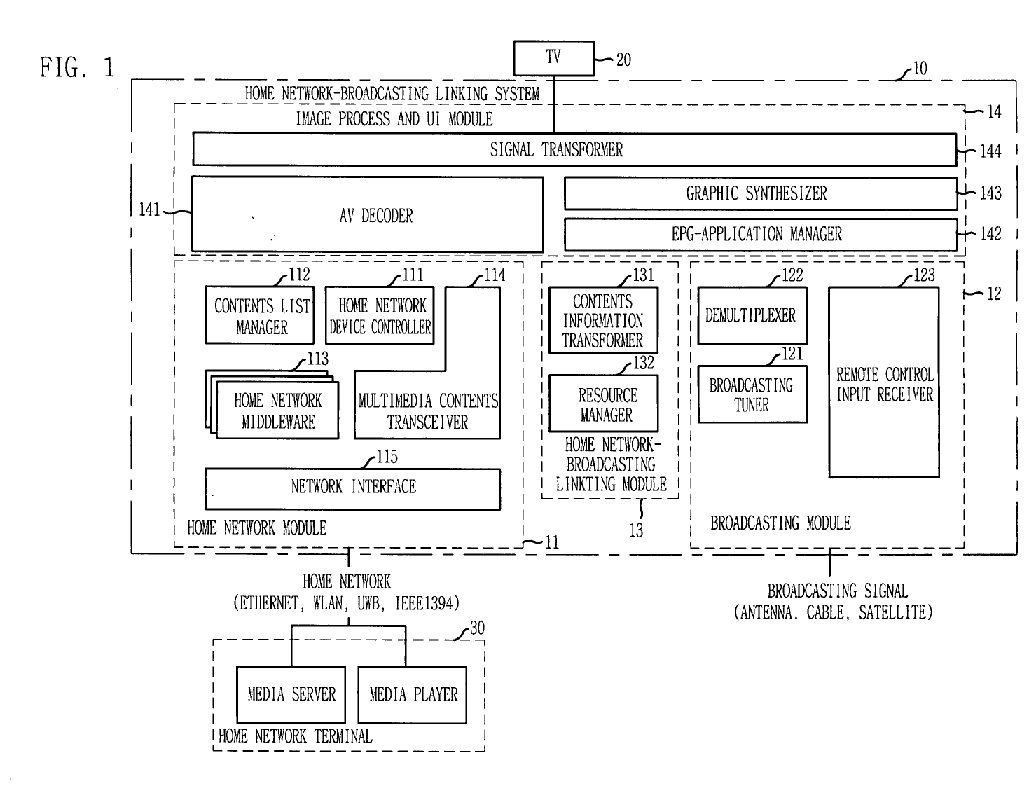

FIG. 1 is a block diagram showing a home network-broadcasting linking system for sharing multimedia contents between a home network and a broadcasting network in accordance with an embodiment of the present invention. It shows a system which makes it possible to use multimedia contents of a home network, i.e., home network multimedia contents, and program contents of broadcasting, i.e., broadcasting contents, in both broadcasting network and home network.

As shown in FIG. 1, a home network-broadcasting linking system 10 of the present invention includes a home network module 11, a broadcasting module 12, a home network-broadcasting linking module 13, and an image process and user interface (UI) module 14.

The home network module 11 will be described in detail hereinafter.

The home network module 11 collects and manages a home network multimedia contents list and a broadcasting contents list whose format is transformed into a format of the home network, provides the contents lists upon request of the home network terminal and repeats the home network multimedia contents or the broadcasting contents for restoration in a home network terminal 30 or a TV 20. Each constituent element will be described hereinafter in consideration of the above functions of the home network module 11.

The home network module 11 communicates with other home network terminals accessing to the home network and acquires/controls information to restore the home network multimedia contents on TV or transmit the broadcasting program contents to the home network terminal.

The home network module 11 performs the following functions to restore home network multimedia contents on TV. The home network module 11 searches for a device accessing to the home network, receives the home network multimedia contents list from a media server storing the home network multimedia contents and transmits the information to the home network-broadcasting linking module 13. Subsequently, the home network module 11 transmits a control command to the media server to restore specific home network multimedia contents upon request of a user and receives contents from the media server.

Meanwhile, the home network module 11 performs the following functions to restore broadcasting program contents in the home network terminal. When another home network terminal, i.e., a media player, requests a broadcasting program contents list, the home network module 11 performs a function based on the control command transmitted from the media player. Also, the home network module 11 transmits the broadcasting program contents to the media player.

As shown in FIG. 10, the home network module 11 includes a home network device controller 111, a contents list manager 112, a home network middleware 113, a multimedia contents transceiver 114 and a network interface 115. Each of the constituent elements will be described in detail hereinafter.

The home network device controller 111 generally controls a home network device, e.g., the home network module 11 and the home network terminal 30, and transmits/receives a control command with home network terminals through the home network middleware 113 to transmit/receive the contents. That is, the home network device controller 111 is a module for controlling a set-top box by transmitting a control command to the home network terminal in order to transmit/receive the contents or receiving the control command from the home network terminal. The home network device controller 111 transmits/receives commands such as restoration, halt and volume control for transmission of the contents.

The home network middleware 113, which is a module realizing a home network middleware, finds out a device accessing to the home network, i.e., a home network terminal, collects a home network multimedia contents list from the found home network terminal and transmits/receives the control command and an event to/from the home network terminals. The module differs based on which home network middleware the set-top box or home server supports.

The contents list manager 112 stores/manages a home network multimedia contents list collected through the home network middleware 113 and a broadcasting program contents list transformed into a form of the home network multimedia contents list, i.e., an extensible markup language (XML) form, and provides the contents list upon request of the home network terminal.

When the home network terminal requests the contents list manager 112 for the contents, the contents list manager 112 requests the contents to another home network terminal or the broadcasting module 12 based on the type of the requested contents. That is, when the contents list manager 112 receives the contents request from the home network terminal, the contents list manager 112 determines the type of the contents, i.e., which of the home network multimedia contents and the broadcasting program contents is the requested contents, based on Uniform Resource Locator (URL) information included in the contents request. When it turns out that the requested contents are the broadcasting program contents, the contents list manager 112 requests to the broadcasting module 12 for the contents based on channel information corresponding to the URL information. When it turns out that the requested contents are the home network multimedia contents, the contents list manager 112 requests the contents to another home network terminal corresponding to the URL address information.

The multimedia contents transceiver 114 transmits the broadcasting program contents to the home network terminals accessing to the home network, or receives the home network multimedia contents from the home network terminals. More particularly, the multimedia contents transceiver 114 receives the contents from another home network terminal or the broadcasting module 12 upon request of the contents list manager 112 and transmits the contents to the home network terminal. Otherwise, the multimedia contents transceiver 114 receives/transmits the home network multimedia contents from the home network terminal upon request of the image process and UI module 14. Herein, the multimedia contents transceiver 114 transmits/receives the contents by using a protocol such as hypertext transfer protocol (HTTP) and routing table protocol (RTP), supported by the home network terminal.

The network interface 115 is used to communicate with the home network terminals and it may be an Ethernet, Ultra Wide Band (UWB), and Institute of Electrical and Electronics Engineers (IEEE) 1394.

The broadcasting module 12 will be described in detail hereinafter.

The broadcasting module 12 receives a broadcasting signal from terrestrial broadcasting, satellite broadcasting, or cable broadcasting to restore the broadcasting program contents on TV. Also, the broadcasting module 12 receives the broadcasting signal transmitted through a broadcasting network, divides the broadcasting signal into a broadcasting contents list and broadcasting contents, and transmits the broadcasting program contents list information to a contents information transformer 131.

As shown in FIG. 1, the broadcasting module 12 includes a broadcasting tuner 121, a demultiplexer 122 and a remote control input receiver 123. Each of the constituent elements will be described in detail hereinafter.

The broadcasting tuner 121 receives only a signal of the channel selected by the user from a terrestrial broadcasting signal, a satellite broadcasting signal, or a cable broadcasting signal receiving all channel signals, and transmit the signal to the demultiplexer 122.

Subsequently, the demultiplexer 122 separates a detailed broadcasting signal from the transmitted broadcasting channel signal. Since the signal transmitted from the broadcasting tuner 121 may have a plurality of contents, the demultiplexer 122 separates contents desired by the user from the signal transmitted from the broadcasting tuner 121 and transmits the contents to an audio/video (AV) decoder 141.

That is, the demultiplexer 122 separates broadcasting program contents and broadcasting program contents list from the broadcasting channel signal transmitted from the broadcasting tuner 121, transmits the broadcasting contents to the AV decoder 141 or the home network module 11, and transmits the broadcasting program contents list to the home network-broadcasting linking module 13. The format of the separated and transmitted broadcasting program contents list is transformed in the home network-broadcasting linking module 13.

Meanwhile, the remote controller input receiver 123 receives user selection information, i.e., a key value inputted by the user through a remote controller, and transmits the user selection information to an Electronic Program Guide (EPG)-application manager 142.

The home network-broadcasting linking module 13 will be described in detail hereinafter.

The home network-broadcasting linking module 13 transforms information between the format of the home network module 11 and the format of the broadcasting module 12 to use the information in both modules. Also, home network-broadcasting linking module 13 approves or disapproves the use of resources for sharing resources of a limited home server, or a set-top box and TV resources. The home network module 11 and the broadcasting module 12 are linked through the home network-broadcasting linking module 13.

As shown in FIG. 1, the home network-broadcasting linking module 13 includes the contents information transformer 131 and a resource manager 132, which will be described in detail hereinafter.

The contents information transformer 131 transforms a home network multimedia contents list of an Extensible Markup Language (XML) format into a broadcasting program contents list format defined in broadcasting, and transmits the broadcasting program contents list to the EPG-application manager 142. Otherwise, the contents information transformer 131 transforms the format of the broadcasting program contents list into the XML format and transmits the transformed contents list to the contents list manager 112. The transformation will be described in detail hereinafter.

First, a process for transforming the format of the broadcasting program contents list into the format of the home network multimedia contents list, i.e., a broadcasting-to-home network format transformation, is as follows.

The broadcasting program contents list transmitted from the broadcasting module 12 includes information on a program title, a channel, a start time, and an end time in each of the program contents. The contents information transformer 131 uses the information for the XML format transformation and creates Unique Resource Location (URL), at which other home network terminals can request the broadcasting program contents. That is, channel information on the broadcasting program contents is expressed in the form of the URL.

Herein, the form of the URL may be “transmission protocol name”://“host IP address”:“host port”/“unique name showing whether it is a broadcasting program”/“broadcasting program contents identifier”/“channel”. For example, when a program called “xxx” is broadcasted on a channel 3 from 10 a.m. to 11 a.m., and the program contents are transmitted based on the HTTP protocol, the URL of the contents is http://1.1.1.1:20000/broadcast/xxx/3. Herein, the URL is to include an identifier showing that the requested contents of the URL are broadcasting contents, an identifier of the broadcasting program contents and the channel information. The broadcasting program contents identifier can be expressed explicitly as the above example or implicitly. That is, although the broadcasting contents are not explicitly identified, the URL can be created meaning the contents are broadcasting contents. Information on start time, end time and a channel of a program are included in a contents list XML text.

Secondly, a process for transforming the format of the home network multimedia contents list into the format of the broadcasting program contents list, i.e., a home network-to-broadcasting format transformation, is as follows.

The home network multimedia contents do not have start time and channel information. Accordingly, when the format of the home network multimedia contents list is transformed into the format of the broadcasting program contents list, ‘start time’ is displayed as a present time or always available, and ‘end time’ is displayed as a time obtained by adding restoration time to the present time, or the restoration time.

A ‘channel’, which is accessible in TV, is allocated to the home network multimedia contents and the allocated channel information is transmitted to the EPG-application manager 142. Herein, there are two methods for allocating channels to contents. One is allocating one channel to one content and the other is allocating one channel to one contents group.

The method for allocating one channel to one content is applied to a content designated by a user, a content having a long restoration time, and a content requiring one channel allocated thereto by other methods. Channels which are not currently used in an entire broadcasting channel, are allocated to the above-mentioned contents.

In the above method, the user can acquire diverse information on home network multimedia contents name, a start time, an end time and a channel on TV through EPG.

Meanwhile, when a home network multimedia contents group is allocated to one channel, a name of representative contents of the contents group, a certain end time, and an allocated channel are displayed. When the user selects a specific channel, a list of the contents group is displayed in the EPG screen.

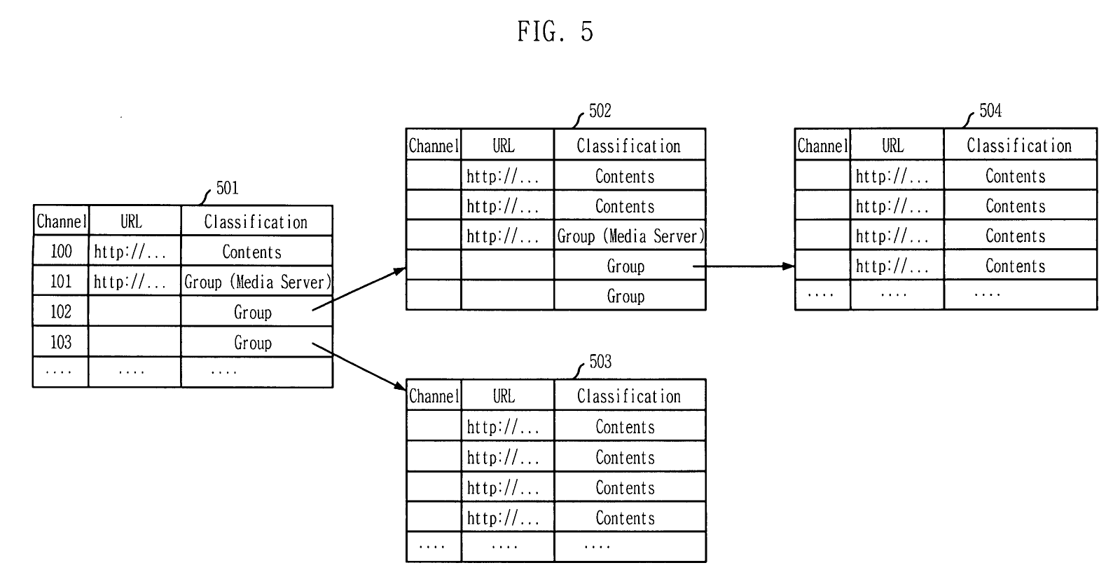

In the method, the channel, which is not currently used in the entire broadcasting channel, is also allocated. The method for allocating a channel to a contents group is the same as the method of FIG. 5.

An example of a case where the method for allocating one channel to a contents group is used in that contents stored in one media server are grouped and stored for one channel. Also, the user can arbitrarily designate the contents group such as channel 30 for action movies, channel 31 for a soap opera, channel 32 for family pictures. All contents in one media server can be treated as one group by designating one media server as a group.

When a specific channel is allocated to the home network multimedia contents, the user does not have to go through EPG to find out the desired contents. The user can watch the desired home network multimedia contents by inputting only the channel anytime.

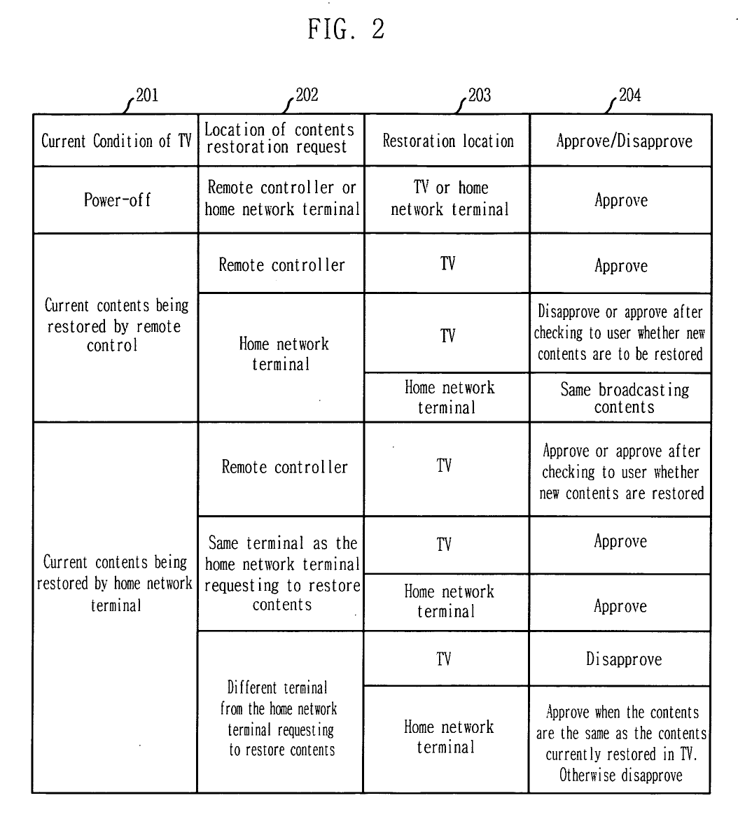

The resource manager 132 is a module for managing resources of TV which cannot simultaneously perform a plurality of works such as a TV screen, a tuner and a speaker. It will be described in detail with reference to FIG. 2.

The image process and UI module 14 will be described hereinafter.

The image process and UI module 14 restores the multimedia contents transmitted from the home network module 11 and the broadcasting module 12 on the TV screen, and EPG information and UI information displayed on the TV screen. More particularly, the image process and UI module 14 provides the home network multimedia contents list and the broadcasting program contents list transformed into a broadcasting format to the user on the TV screen, and transmits user selection information to the home network module 11 or the broadcasting module 12 based on the type of the contents selected by the user. Subsequently, the image process and UI module 14 receives the home network multimedia contents or the broadcasting contents, and processes an image signal to restore the home network multimedia contents or the broadcasting contents on TV.

As shown in FIG. 1, the image process and UI module 14 includes the AV decoder 141, the EPG-application manager 142, a graphic synthesizing unit 143 and a signal transformer 144. Each of the constituent elements will be described as follows.

The AV decoder 141 decodes contents data transmitted from the home network module 11 and the broadcasting module 12. Since the contents data transmitted from the home network module 11 and the broadcasting module 12 are encoded in a method such as Moving Picture Experts Group (MPEG) and windows media video (WMV), the contents data are required to be decoded for restoration.

The EPG-application manager 142 provides EPG information including the home network multimedia contents list and the broadcasting program contents list to the user with the UI information on the TV screen, and transmits the user selection information to the broadcasting module 12 or the home network module 11 based on the type of the contents selected by the user.

It will be described in detail hereinafter. The EPG-application manager 142 displays the EPG information and the UI information on the TV screen. Also, since the EPG-application manager 142 has the URL of the home network multimedia contents and the mapping table of the channel, which will be called a ‘channel-URL mapping table’ hereinafter, the EPG-application manager 142 can determine whether the channel selected by the user is of the broadcasting program contents or of the home network multimedia contents. When no channel information is selected by the user in the channel-URL mapping table, it is determined that the home network multimedia contents are selected. Otherwise, it is determined that the broadcasting program contents are selected.

When it turns out that the channel information on the broadcasting program contents is selected by the user, the channel information is transmitted to the broadcasting module 12. When the channel information is of the home network multimedia contents, the channel information is changed into the URL address information and transmitted to the home network module 11.

Meanwhile, the graphic synthesizing unit 143 synthesizes the EPG screen and the UI information with the image screen of the multimedia contents decoded in the AV decoder 141 to simultaneously display the EPG screen and UI information can be with the contents image on the TV screen.

Subsequently, the signal transformer 144 transforms digital image data outputted in the graphic synthesizing unit 143 into an analog image signal such as S-Video, Component and Composite.

FIG. 2 is a policy table used for determining whether to restore contents in the resource manager of FIG. 1.

The resource manager 132 manages resources of TV which cannot simultaneously perform a plurality of works such as a TV screen, a tuner and a speaker.

When the home network multimedia contents are to be restored, the resource manager 132 checks a current condition of TV at step S201, a restoration request location of the home network multimedia contents at step S202, and a restoration location at step S203. Subsequently, the resource manager 132 determines whether to approve or disapprove the restoration request of the contents based on the above check result at step S204. Whether the contents are to be restored will be determined in the method of FIG. 2.

That is, the resource manager 132 determines whether to restore the contents by the method shown in FIG. 2 or a similar method before restoring the contents requested by the user through the TV resources shared by the home network module 110 and the broadcasting module 12.

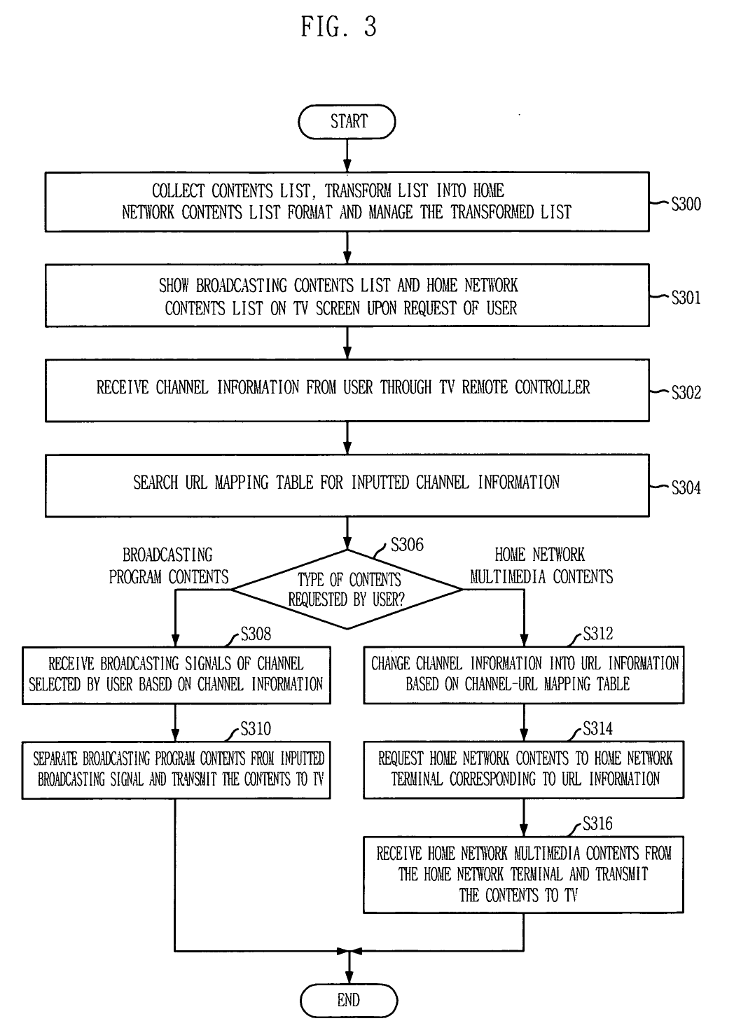

FIG. 3 is a flowchart describing a home network-broadcasting linking method for restoring the home network contents and/or broadcasting contents on TV in accordance with an embodiment of the present invention. It shows a method performed in the home network-broadcasting linking system 10. That is, FIG. 3 shows a method for transmitting the broadcasting contents or the home network multimedia contents to TV to restore the broadcasting contents or the home network multimedia contents on TV.

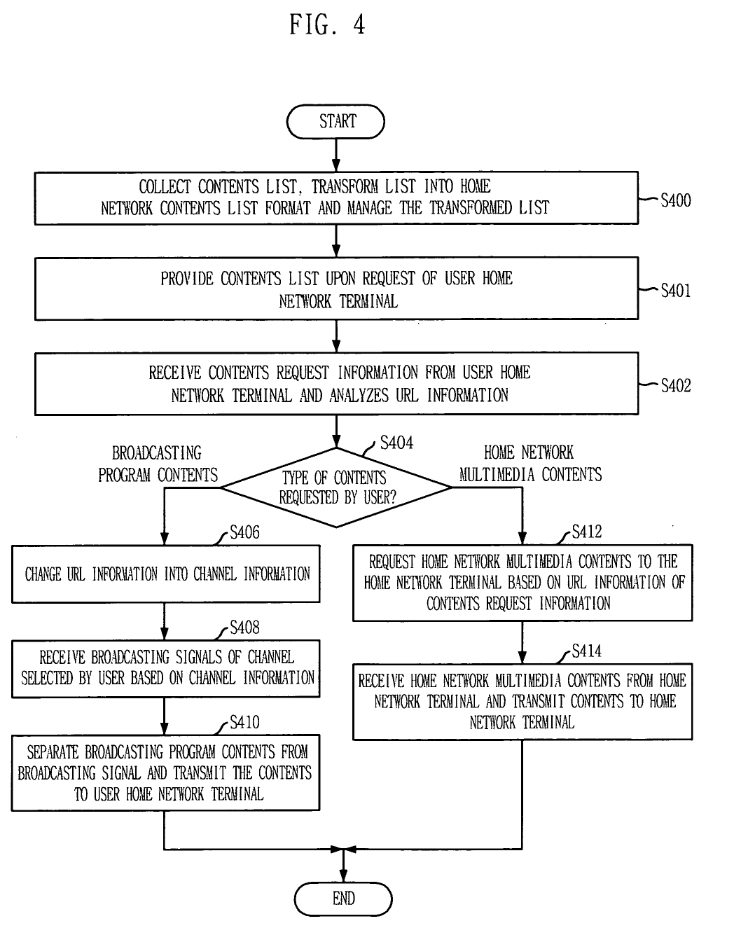

The user can restore the contents on TV or home network terminal by using a TV remote controller and the home network terminal. There are a method for restoring the home network multimedia contents on TV and a method for restoring the broadcasting program contents in the home network terminal. The former will be described with reference to FIG. 3 and the latter will be described with reference to FIG. 4.

The home network-broadcasting linking system 10 collects the home network multimedia contents list in the home network terminals, transforms the format of the home network multimedia contents list into the broadcasting contents list format and manages the contents. Also, the home network-broadcasting linking system 10 collects the broadcasting contents list from the broadcasting signal, transforms the format of the broadcasting contents list into the home network multimedia contents list format and manages the contents at step S300.

The image process and UI module 14 provides the broadcasting contents list and the home network multimedia contents list on the screen of the TV 20 at step S301 by operating the EPG upon request of the user. That is, when the user operates the EPG by the TV remote control, the home network multimedia contents list as well as the broadcasting program contents list can be displayed. Herein, the home network multimedia contents list also includes the broadcasting channel information.

When channel information is inputted from the user through the TV remote controller at step S302, the EPG-application manager 142 determines at steps S304 and S306 which contents the user requests among the home network multimedia contents and the broadcasting program contents based on a channel-address URL mapping table of FIG. 5. That is, when the user inputs the channel with the remote controller, the inputted channel is transmitted to the EPG-application manager 142 through the remote control input receiver 123. The EPG-application manager 142 searches the channel-URL mapping table and determines the type of the contents requested by the user. Herein, it is checked at step S304 whether the channel information inputted by the user exists in the channel-address URL mapping table. When the inputted channel information does not exist in the channel-address URL mapping table, it is determined at step S306 that the user requests the broadcasting program contents. When the inputted channel information exists in the channel-address URL mapping table, it is determined at step S306 that the user requests the home network multimedia contents.

When the channel information is transformed from the user, a resource managing process (not shown in FIG. 3) that the resource manager 132 determines whether to approve the contents restoration on TV based on the current condition of TV, the restoration request location of the contents and the contents restoration location can be added to the above processes. The contents can be transmitted only when the restoration is approved through the resource managing process.

When the contents requested by the user are the broadcasting program contents, the EPG-application manager 142 transmits the channel information to the broadcasting module 12. Subsequently, the broadcasting module 12 receives the broadcasting signal of the channel selected by the user based on the channel information at step S308, separates the broadcasting program contents from the inputted broadcasting signal and transmits the broadcasting program contents to TV at step S310. The transmitted broadcasting program contents are restored on TV.

When it turns out that the contents requested by the user are the home network multimedia contents, the EPG-application manager 142 changes the channel information into address URL information based on the channel-address URL mapping table and transmits the address URL information to the home network module 11 at step S312. Herein, the channel-address URL mapping table includes channel information allocated for each of the home network multimedia contents and URL information of the home network terminal providing the home network multimedia contents. When the home network multimedia contents group is allocated to the channel information of the user, the EPG-application manager 142 is finally selected by the user through a process providing additional contents group information to the user and changed into URL address information for the finally selected contents as shown in FIG. 5.

The home network module 11 requests for home network multimedia contents to a home network terminal corresponding to address URL information at step S314, receives home network multimedia contents from the home network terminal and transmits the home network multimedia contents to TV through the image process and UI module 14 at step S316. The transmitted home network multimedia contents are restored on TV.

When the contents group is allocated to a channel inputted by the user, the EPG-application manager 142 additionally provides UI information providing the contents group information to the user such that the user can select the desired contents. When the user selects specific contents in the contents group, the EPG-application manager 142 transmits the selected contents information to the home network module 11 based on the URL information. Subsequently, the home network module 11 requests contents to the home network terminal, i.e., a media server, receives the contents and transmits the contents to TV through the image process and UI module 14.

FIG. 4 is a flowchart describing a home network-broadcasting linking method for restoring the broadcasting contents and/or home network multimedia contents in the home network terminal in accordance with an embodiment of the present invention. It shows a method operated in the home network-broadcasting linking system 10. That is, FIG. 4 shows a method for transmitting the broadcasting contents or the home network multimedia contents to the home network terminal such that the broadcasting contents or the home network multimedia contents can be restored in the home network terminal.

The home network-broadcasting linking system 10 collects a home network multimedia contents list from home network terminals, transforms the format of the home network multimedia contents list into a broadcasting contents list format and manages the contents list. Also, the home network-broadcasting linking system 10 collects a broadcasting contents list from the broadcasting signal, transforms the format of the broadcasting contents list into a home network multimedia contents list format and manages the contents list at step S400.

The home network module 11 provides the broadcasting program contents list and the home network multimedia contents list upon request of the user home network terminal 30 at step S401.

Subsequently, the user requests the broadcasting program contents by using the home network terminal. The user request is expressed as URL information and transmitted to the home network module 11. Herein, the URL information includes an identifier identifying the broadcasting contents request, a broadcasting program contents identifier and channel information.

When the home network module 11 receives contents request information from user home network terminal, the home network module 11 determines the type of the contents through URL information, i.e., address information of the requested contents, at steps S402 and S404. That is, the home network module 11 analyzes the URL information and determines which contents the user requests among the broadcasting program contents and the home network multimedia contents.

When the user home network terminal requests a content, a resource managing process (not shown in FIG. 4) that the resource manager 132 determines whether to approve content restoration in the home network terminal based on a current condition of TV, a restoration request location of the contents, and a contents restoration location can be added to the above processes. The content can be transmitted only when the restoration is approved through the resource managing process.

When it turns out that the requested contents are the broadcasting program contents, the home network module 11 changes URL information included in the contents request information into channel information and transmits the channel information to the broadcasting module 12 at step S406. Herein, the URL can be easily changed into the channel information by acquiring the channel information through only the URL, because the channel information is inserted when the URL is created.

The broadcasting module 12 receives a broadcasting signal of the channel selected by the user based on the changed channel information at step S408, separates broadcasting program contents from the broadcasting signal and transmits the broadcasting program contents to the user home network terminal 30 through the home network module 11 at step S410. That is, when the broadcasting module 12 transmits the broadcasting program contents to the home network module 11, the home network module 11 transmits the broadcasting program contents to the user home network terminal 30.

The broadcasting program contents to be transmitted to the home network terminal 30 can include program contents to be broadcasted as well as contents which are currently being broadcasted.

When the broadcasting program contents requested by the user are the contents which are currently being broadcasted, the contents is instantly restored in the home network terminal. When the broadcasting program contents requested by the user are the contents to be broadcasted later, the contents are reserved in the home network terminal 30 and the home network-broadcasting linking system 10. Accordingly, when the contents starts, the broadcasting module 12, the home network module 11, and the resource manager 132 are automatically operated and the contents are restored in the home network terminal. That is, the broadcasting module 12 waits with the channel information on the broadcasting program contents to be broadcasted later, and receives a broadcasting signal when the broadcasting of the contents starts.

Meanwhile, the requested contents are the home network multimedia contents, the home network module 11 requests home network multimedia contents to the home network terminal based on URL information of contents request information at step S412. Accordingly, when the home network module 11 receives the home network multimedia contents from the home network terminal, the home network module 11 transmits the contents to home network terminal at step S414.

Just as the method of FIGS. 3 and 4, when the broadcasting program contents or the home network multimedia contents are restored on TV, or when the broadcasting program contents are restored in the home network terminal, the contents can be restored only when it is determined whether the resource manager 132 approves the use of resources before the contents restoration. From this, limited resources can be efficiently used.

FIG. 5 shows a method for organizing mapping information between channels and URL in the EPG-application manager in accordance with an embodiment of the present invention.

As shown in FIG. 3, when a home network multimedia contents group is allocated to the channel information of the user, the user finally selects contents through a process that the EPG-application manager 142 provides additional contents group information to the user. URL information of the finally selected contents is the URL information on the contents selected by the user.

The URL information can be acquired for each of the contents 501, 502, 503 and 504. One content is finally selected for the contents group through the additional contents group information continuously provided as reference numbers 502, 503 and 504. The URL information on the channel information selected by the user through the above process is mapped.

According to the present invention, the home network terminal, i.e., the terminal accessing to the home network, recognizes the broadcasting program contents list, restore the contents, and it also recognizes and restores the home network multimedia contents on TV. Accordingly, the home network multimedia contents and the broadcasting program contents existing as a file or other formats can be used in both of the home network terminal and TV without any difference.

That is, the system of the present invention can search and restore the home network multimedia contents and the broadcasting multimedia contents in the home network terminal or TV as long as it has network interface.

As described above, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent application No. 2005-0114392, filed with the Korean Intellectual Property Office on Nov. 28, 2005, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A home network-broadcasting linking system for using multimedia contents of a home network and program contents of a broadcasting network in both broadcasting network and home network, comprising:
a home network means which collects/manages a home network multimedia contents list and a broadcasting contents list whose format is transformed into a home network format, provides the home network multimedia contents list or the broadcasting contents list upon request of a home network terminal, and repeats the requested contents for restoration in the home network terminal or on TV;
a broadcasting means which receives a broadcasting signal transmitted through the broadcasting network and divides the broadcasting signal into the broadcasting contents list and the broadcasting contents;
a home network-broadcasting linking means which transforms the home network multimedia contents list collected in the home network means into a broadcasting contents list format, transforms the broadcasting contents list separated from the broadcasting means into a home network multimedia contents list format and transmits the broadcasting contents list of the home network format to the home network means; and
an image process and user interface (UI) means which provides the home network multimedia contents list of the broadcasting format and the broadcasting contents list, transmits user selection information to the home network means or the broadcasting means based on a type of the contents selected by the user, receives the home network multimedia contents or the broadcasting contents and performs an image signal process on the home network multimedia contents or the broadcasting contents for restoration on TV.

2. The system as recited in claim 1, wherein the home network means includes:
a middleware which finds out the home network terminals accessing to the home network, collects the home network multimedia contents list and transmits/receives a control command and an event to/from the home network terminals;
a contents list manager which stores and manages the collected home network multimedia contents list and the broadcasting contents list of the home network format, and provides a contents list among the home network contents list and the broadcasting contents list upon request of the terminal;
a home network device controller which transmits/receives the control command to/from the home network terminals through the middleware for transmission/reception of the contents in the home network means;
a contents transmitter/receiver which receives contents from the another home network terminal or the broadcasting means upon request of the contents list manager and transmits the contents to the home network terminal, or which receives the home network multimedia contents from the home network terminal and transmits the home network multimedia contents to the image process and UI means upon request of the image process and UI means; and
a network interface which performs interface for communication with the home network terminals.

3. The system as recited in claim 2, wherein the contents list manager receives contents request information from the home network terminal, determines the type of the contents based on Unique Resource Location (URL) information included in the contents request, requests the broadcasting means for the contents based on channel information corresponding to the URL information in case that the requested contents are the broadcasting contents, or requests for the contents to another home network terminal corresponding to the URL address information in case that the requested contents are the home network multimedia contents.

4. The system as recited in claim 3, wherein the image process and UI means includes:
Electronic Program Guide (EPG)-application manager which provides EPG information including the home network multimedia contents list and the broadcasting contents list to the user through a TV screen with UI information, and transmits the user selection information to the broadcasting means or the home network means based on the type of the contents selected by the user;
an audio/video (AV) decoder which decodes the contents transmitted from the home network means or the broadcasting means;
a graphic synthesizer which synthesizes image information of the contents decoded in the AV decoder with the EPG information and the UI information; and
a signal transformer which transforms digital image data outputted from the graphic synthesizer into analog image signals.

5. The system as recited in claim 4, wherein the EPG-application manager determines the type of the contents selected by the user based on mapping information between the URL of the home network multimedia contents when the user selection information is channel information, transmits the channel information to the broadcasting means when the contents are the broadcasting contents, changes the channel information into URL address information when the contents are the home network multimedia contents, and transmits the URL address information to the home network means.

6. The system as recited in claim 5, wherein the EPG-application manager provides additional contents group information to the user when a home network multimedia contents group is allocated to the channel information of the user, and changes the contents group information into URL address information on the home network multimedia contents which are finally selected by the user.

7. The system as recited in claim 6, wherein the broadcasting means includes:
a broadcasting tuner which receives only the broadcasting signals of the channel selected by the user among broadcasting signals transmitted through the broadcasting network;
a demultiplexer which separates the broadcasting contents and the broadcasting contents list from the broadcasting channel signal transmitted from the broadcasting tuner, transmits the broadcasting contents to the AV decoder or the home network means and transmits the broadcasting contents list to the home network-broadcasting linking means; and
a remote control input receiver which receives selection information inputted from the user through a remote controller, and transmits the selection information to the EPG-application manager.

8. The system as recited in claim 7, wherein the home network-broadcasting linking means includes:
a contents information transformer which transforms the format of the home network multimedia contents list into the broadcasting contents list format defined in broadcasting, transmits the home network multimedia contents list of the broadcasting contents list to the EPG-application manager, transforms the broadcasting contents list into the home network multimedia contents list format and transmits home network multimedia contents list to the contents list manager; and
a resource manager which determines whether the contents are to be restored based on a current condition of TV, a restoration request location of the contents, and a contents restoration location, before the contents are restored on TV.

9. The system as recited in claim 8, wherein in the broadcasting-to-home network format transforming process of the contents information transformer, the broadcasting contents list is transformed into an Extensible Markup Language (XML) format, and the channel information on the broadcasting contents, is expresses as URL information.

10. The system as recited in claim 9, wherein the URL information includes an identifier showing that the URL is related to the broadcasting contents, an identifier of the broadcasting contents and channel information.

11. The system as recited in claim 8, wherein in a home network-to-broadcasting format transforming process of the contents information transformer, ‘start time’ is expressed as a present time or always available; ‘end time’ is expressed as a time obtained by adding a restoration time to a current time; and ‘channel’ is allocated to the home network multimedia contents to make TV access to the home network multimedia contents.

12. The system as recited in claim 11, wherein when the channel is allocated to the home network multimedia contents, one channel which is not used as the broadcasting channel is allocated to each of the home network multimedia contents or every home network multimedia contents group.

13. The system as recited in claim 12, wherein when the channel is allocated to the home network multimedia contents group, the home network multimedia contents list transformed into the broadcasting format further includes a name of representative contents and a list of the contents group.

14. A method for linking a home network with a broadcasting network to restore broadcasting program contents or home network multimedia contents on TV, comprising the steps of:
a) collecting a home network multimedia contents list from home network terminals, transforming the format of the home network, managing the home network multimedia contents list into a broadcasting contents list format, collecting a broadcasting contents list from the broadcasting signal, transforming the format of the broadcasting contents list into the home network multimedia contents list format, and managing the broadcasting contents list and the home network multimedia contents list;
b) operating Electronic Program Guide (EPG) upon request of a user and providing the broadcasting contents list and the home network multimedia contents list which are managed in the step a) through TV;
c) determining which of the home network multimedia contents and the broadcasting contents are requested by the user based on channel-address mapping information when the channel information is inputted from the user;
d) when the contents requested by the user are the broadcasting contents, receiving the broadcasting signal of the channel selected by the user based on the channel information, and separating the broadcasting contents from the transmitted broadcasting signal and transmits the broadcasting contents to TV; and
e) when the contents requested by the user are the home network multimedia contents, changing the channel information into address information based on the channel-address mapping information, requesting a home network terminal corresponding to the address information for the requested contents, and transmits the transmitted home network multimedia contents to TV.

15. The method as recited in claim 14, further comprising a step of:
f) determining whether to approve contents restoration on TV based on a current condition of TV, a restoration request location of the contents, and a contents restoration location, when the channel information is inputted from the user.

16. The method as recited in claim 14, wherein in the step c), whether the channel information exists in the channel-address mapping information is checked, and are determined to be the contents requested by the user the broadcasting contents when the selected channel information does not exist; otherwise, the contents requested by the user are determined to be the home network multimedia contents.

17. The method as recited in claim 16, wherein in the channel information input process of the step c), the channel information is directly inputted from the user through a remote controller of TV.

18. The method as recited in claim 17, wherein in the step d), when the contents group is allocated to the inputted channel information, the contents are selected by providing contents group information to the user and a corresponding home network terminal is requested to transmit the selected contents information based on address information.

19. The method as recited in claim 18, wherein the channel-address mapping information includes channel information allocated to each of the home network multimedia contents and URL information of the home network terminal providing the home network multimedia contents.

20. A method for linking a home network with a broadcasting network to restore broadcasting program contents or home network multimedia contents in the home network terminal, comprising the steps of:
a) collecting a home network multimedia contents list from home network terminals, transforming the home network multimedia contents list into a broadcasting contents list format, and managing the contents list collecting a broadcasting contents list from broadcasting signals, transforming the broadcasting contents list into the home network multimedia contents list format and managing the contents list;
b) providing the broadcasting contents list and the home network multimedia contents list which are managed in the step a) upon request of the user home network terminal;
c) receiving contents request information from the user home network terminal and determining a type of the contents based on address information of the requested contents;
d) when the requested contents are the broadcasting contents, receiving broadcasting signals of a channel selected by the user based on channel information corresponding to address information of the contents request information, separating the broadcasting contents from the transmitted broadcasting signals and transmitting the broadcasting contents to the user home network terminal; and
e) when the requested contents are the home network multimedia contents, requesting for the home network multimedia contents to the home network terminal corresponding to the address information of the contents request information, and transmitting the home network multimedia contents transmitted in response to the home network contents request to the user home network terminal.

21. The method as recited in claim 20, further comprising the step of:
f) determining whether to approve contents restoration in the home network terminal based on a current condition of TV, a restoration request location of the contents, and a contents restoration location, when the user home network terminal requests the contents.

22. The method as recited in claim 20, wherein whether the requested contents are the broadcasting contents or the home network multimedia contents is determined in the step c) by analyzing the address information included in the contents request message.

23. The method as recited in claim 22, wherein the step d) includes the steps of waiting with the channel information when the requested contents are future broadcasting contents to be broadcasted later, receiving the broadcasting signals at a start time of the broadcasting contents, separating the broadcasting contents from the transmitted broadcasting signals, and transmitting the broadcasting contents to the user home network terminal.

24. The method as recited in claim 23, wherein the address information is URL address information and includes an identifier showing that the address information is the broadcasting contents request, an identifier of the broadcasting contents, and channel information.
